(19) United States
(12) Patent Application Publication
(10) Pub. No.: US 2005/0192082 A1
(43) Pub. Date: Sep. 1, 2005

(54) Prize machine

(76) Inventor: Richard Wilson, Newark (GB)

Correspondence Address: GLENN PATENT GROUP, 3475 EDISON WAY, SUITE L, MENLO PARK, CA, 94025, US

(21) Appl. No.: 11/047,838

(22) Filed: Jan. 31, 2005

(30) Foreign Application Priority Data
Jan. 30, 2004 (GB) GB 0402037.6
Apr. 16, 2004 (GB) GB 0408509.8

(51) Int. Cl. G06F 17/00; G06F 19/00; A63F 9/24

(52) U.S. Cl. 463/20; 463/42

(57) ABSTRACT

A prize machine (100) is arranged to periodically provide an opportunity to win a free prize, the machine (100) being further arranged such that the opportunity to win the free prize is provided free of charge. This may enable limitations on the value of a pay-to-play prize machine prize to be avoided and therefore the machine (100) may be able to offer higher value prizes than was previously possible.

### CROSS REFERENCE TO RELATED APPLICATIONS

This application claims priority to Great Brittain patent application serial number GB 0402037.6 filed Jan. 30, 2004 and Great Brittain patent application serial number GB 0408509.8 filed Apr. 16, 2004 the contents of both of which are incorporated by reference here in their entirety by this reference.

### FIELD OF THE INVENTION

This invention relates to a prize machine and especially, but not exclusively, to entertainment machines, which may be video display entertainment machines that are generally coin, token, credit, or credit-card, freed for play.

### BACKGROUND OF THE INVENTION

It will be appreciated that an offer to win money is highly attractive to many people. For example, gambling using entertainment machines and other means is a popular pastime and there are a great number of gambling games available. In order to attract players, it is advantageous to provide new features on these games. Further, it is advantageous that the prizes offered by such machines be tempting to a player such that the machine will be played more frequently.

Prize draws are also used in advertising, perhaps to encourage a customer to provide their contact details which can then be used to form a mailing list or simply to encourage a person to take note of a product or service.

Prior art Prize machines, for example WO03/0873789 in the name of IGT, have allowed a bonus game to be bought without requiring the play of a primary game.

The skilled person will however appreciate that prizes are often restricted by legislation or other reason.

### SUMMARY OF THE INVENTION

According to a first aspect of the present invention there is provided a prize machine arranged to periodically to provide an opportunity, free of charge to a user, to win a free prize.

The skilled person will appreciate that, while the prizes on ‘pay-to-play’ machines may be limited according to rules or legislation, there may be, in some jurisdictions, no such limitation on free prizes. This is because the offer of a free prize is not an offer to gamble as no money is risked. Thus a free prize can be of higher, and potentially unlimited, value when compared to the prize that may be offered for a ‘pay-to-play’ machine. Offering a high value prize would make the machine of great interest to a user and as such may be provided as a means of promotion.

In a preferred embodiment the prize machine may comprise an entertainment machine which may be any of the following non-exhaustive list (using the definitions of the current UK gaming legislation): an AWP machine (Amusement With Prizes); an entertainment machine; an SWP machine (Skill With Prizes); a gaming machine.

Such an entertainment machine may be arranged to offer a pay-to-play prize, won following payment to the machine, in addition to the free prize.

The opportunity to win the free prize may be offered roughly at any of the following times: once a month, once a week, once a day, once an hour, once every quarter of an hour, any other time period in between, on a random or pseudo-random basis or as determined by the value of a prize fund.

The free prize may be of fixed value. Alternatively, the value of the free prize may vary. In some embodiments, the value of the free prize is at substantially two levels: a first level and a second level. In such embodiments, the prize machine may be arranged to pay out free prizes at the first level and prizes at the second level (which may be higher than the first level) are claimed in an alternative manner.

The period between prizes being won may be variable. This is advantageous as, if a user could predict when the free prize was more likely to become available, they may lose interest in the prize machine at other times—this may be a particular problem when the prize machine is an entertainment machine. In a preferred embodiment prizes of the first level are paid out more frequently than prizes of the second level.

The prize machine may be arranged to provide a first service and the opportunity to win the free prize may be provided as a second service. The first service may comprise one or more of the following: a game, a television signal, music, multimedia service, telephone services, goods vending or some other service.

Arranging the prize machine in this way is advantageous as it may encourage users to make use of the first service, for which there may be a charge, in the hope that the opportunity to win the free prize will arise during use of the first service. Such a machine may therefore be made more profitable by the provision of the second service. The free prize provided by the second service may also create interest in a machine and thereby serve to entice users to the prize machine.

The pay-to-play prize may be offered in the event of winning a game provided by the first service and the free prize may be offered in the event of winning a game provided by the second service.

The game provided by the second service may be a game of skill, chance or may be decided according to some other rule. It will be appreciated that the free prize may not be won every time it is made available. Indeed, the free prize may be offered substantially more frequently than it is won. This may be achieved through making the second service hard and/or impossible to win on any given occasion.

In one embodiment, each time the first service is used, the value of the free prize is increased. This is advantageous as it may encourage players to use the first service in the hope that, should the second service be made available, the winnings would be increased.

In embodiments where the value of the free prize is at a first or a second level, the value of the first level may increase each time the first service is used.

The value of the second level of free prize may be independent of the amount of times that the first service is used.

Alternatively, or additionally, the prize machine may have a means allowing at least one prize fund to be accessed and be arranged such that the free prize is provided from one or more of the prize funds, the machine being further arranged such that the value of the at least one of the prize funds increases each time the first service is used. A free prize may be made available when the prize fund has reached a predetermined threshold value and/or the value of the free prize may depend on the value of the prize fund.

In an alternative, or additional, embodiment, the value of the free prize may be increased over time, perhaps at a constant rate but more preferably at a non constant rate. A non-constant rate is thought to be preferable in order that a player cannot anticipate the next increment of the free prize.

Alternatively or additionally, the machine may be arranged such that the duration of use of the first service is time-limited. This may be advantageous as a player may attempt to monopolise a machine by using the first service slowly in an attempt to prolong their time at the prize machine and thereby their chance that the second service will be made available to them. It is advantageous for this to be discouraged, as the prize machine will not be collecting maximum revenue at that time.

The prize machine may further comprise a prize display means arranged to display the value of a free prize, which may be the highest value of the free prize available at the time. However, alternative embodiments may be provided that do not reveal the value of a free prize to a user. It is conceivable that a prize display may be arranged to show the value of a free prize at some times but not others. The prize display means may, or may not, be arranged to show an increment to the free prize.

The prize machine may comprise a connection means arranged to allow the machine to connected to one or more of the following non-exhaustive list: a further prize machine, a prize display means, a network of prize machines, a computer network, a telecommunication network, or the like.

The prize machine may comprise a free prize award mechanism. The mechanism may comprise any of the following non-exhaustive list: a cash dispenser, a token dispenser, a ticket dispenser, a ticket printer, or the like. Alternatively the prize machine may be arranged to display instructions to instruct a person who has won the free prize on how to receive the free prize.

Alternatively or additionally, the prize machine may comprise an input means such that the winner of a free prize can input details into the machine. In some embodiments, the input details comprise contact details for the winner and/or a passcode. This may be advantageous as high value prizes could be collected by the winner at a later date and such high value prizes need not be contained within the prize machine or at the location that the prize machine is kept. This may assist in ensuring the security of the high value prize.

The prize machine may be arranged such that the mechanism used for issuing a free prize depends on the value of the prize. In some embodiments, free prizes of value up to a predetermined threshold value may be paid from the prize machine and free prizes above that value may be awarded in some other. Prizes below the predetermined threshold may constitute free prizes of the first level and prizes at or above the predetermined threshold may constitute free prizes of the second level.

According to a second aspect of the present invention there is provided a network of prize machines according to the first aspect of the invention.

The network of machines may be arranged to offer the same free prize such that any one machine can award that prize to a user thereof.

This is advantageous as the offer of a single large free prize may entice users to use the prize machines connected to the network. This allows the machine provider to offer a higher prize than would otherwise be economically viable. Further, the cost of marketing per site is reduced.

In some embodiments, the network may be arranged such that the use of any one of the prize machines connected to the network causes the value of the free prize to be incremented. This is advantageous as it provides a means for funding the free prize. Further, a user may be encouraged to use the prize machine in order to increase the value of the free prize.

In some embodiments at least one of the prize machines connected to the network is arranged to offer a free prize at a first level and at a second level. Use of any one of the prize machines connected to the network may cause the value of the first level of free prize of that machine to be incremented. The value of a prize second at the second level may be funded from an alternative source when compared to the first level of free prize. Prizes at the first level may generally be of lower value than prizes at the second level.

It will be appreciated that the machine may be arranged such that all, or substantially all, of the prize(s) awarded by the machine are paid from the machine. Alternatively, all of the free prize(s) awarded from a machine may be paid from an alternative source.

In such embodiments each prize machine comprises processing circuitry and the value, frequency and/or timing of the offer of a free prize at the first level may be determined by the processing circuitry of the machine. The network may comprise a processing means capable of communicating with each the machines connected to the network and arranged to determine the value, frequency and/or timing of, and the machine on which the offer of a free prize at the second level is made.

Preferably, the network comprises at least one prize display means. The or each prize display means may be in view of the user of a machine, in the vicinity of one or more prize machines or remote from one or more of the prize machines. The network may comprise one prize display means for each prize machine; or alternatively or additionally a prize display means for each location of machines may be provided. This is advantageous as the prize display means can serve to advertise the presence of free prize and also its value. It can therefore entice users to a machine and also to encourage users to maintain use of a machine.

According to a third aspect of the present invention there is provided a method of increasing the player appeal of a prize machine by providing an unlimited value prize, the method comprising providing a prize machine and periodically causing the prize machine to offer a game awarding a free prize without requiring any payment to be made.

The method may further comprise offering a first service from the prize machine when the provision of the game having a free-prize constitutes a second service.

The first service may comprise a game, a television signal, music, multimedia service, telephone services, goods vending or some other service.

The method may further comprise providing a condition for awarding the prize wherein the condition must be satisfied before the prize is awarded.

The condition may comprise winning a game, making an input or some other condition.

Preferably, the method is arranged to increase the value of the free prize.

The method may comprise increasing the free prize with time or with use of the prize machine or based on some other criteria.

The method may comprise providing at least two levels of free prize, free prizes at one such level being paid out from the prize machine and prizes at the another level being award through some other means.

The method may comprise increasing the free prize at one level with time or with use of the prize machine or based on some other criteria. The method may further comprise maintaining the value of the free prize at another level.

The method may comprise allowing a machine to determine when a prize of the first level is paid therefrom. Further, the method may comprise informing the machine when a prize of a second level may be paid therefrom.

The method may comprise connecting the prize machine to a network. This is advantageous as the prize machine may then be controlled remotely and further as a plurality of prize machines can be operated in a coordinated and secure fashion.

### BRIEF DESCRIPTION OF THE DRAWINGS

Embodiments of the invention are now described by way of example only and with reference to the accompanying Figures of which:

FIG. 1 shows an entertainment machine according to one embodiment of the present invention;

FIG. 2 shows a flowchart outlining the award of a prize from an entertainment machine;

FIG. 3 shows a local area network of entertainment machines according to one embodiment of the present invention;

FIG. 4 shows a plurality of entertainment machines connected to a network according to one embodiment of the present invention.

### DETAILED DESCRIPTION OF THE DRAWINGS

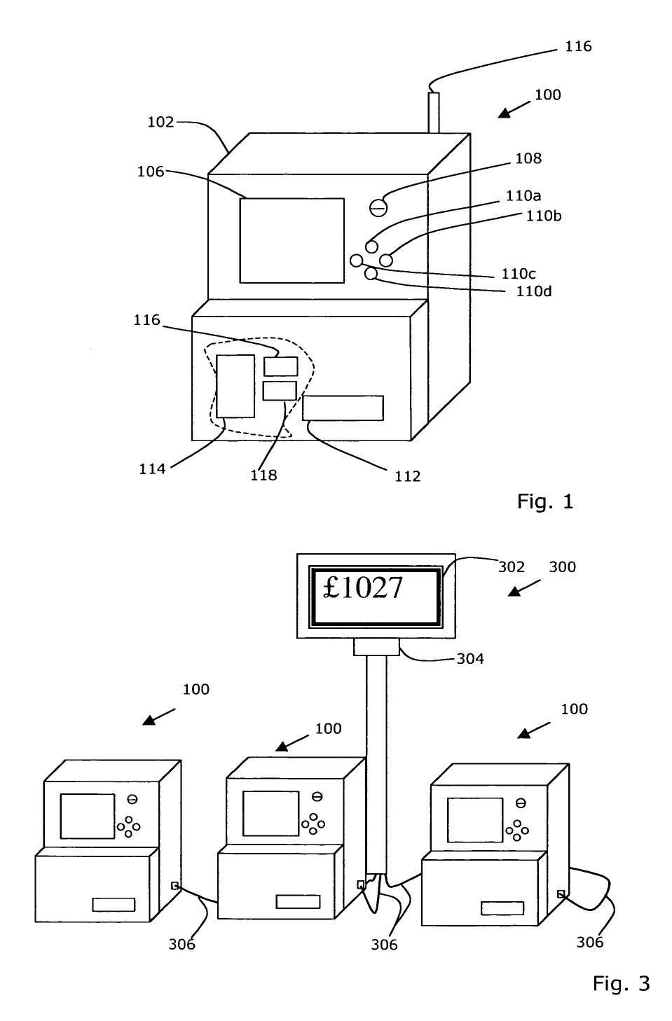

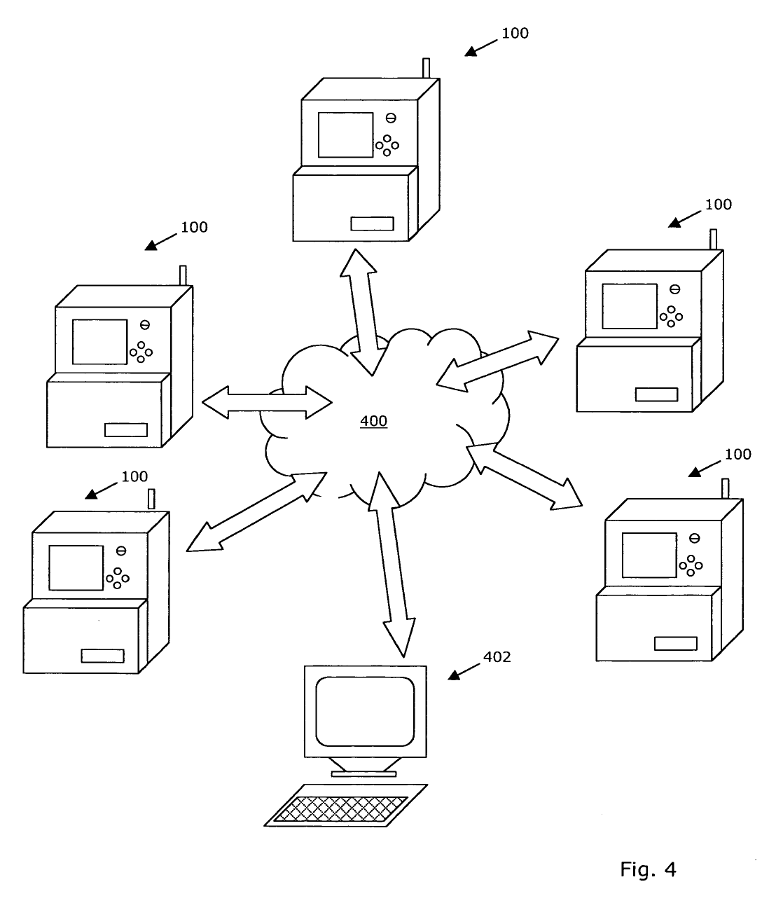

In one embodiment of the present invention, a prize machine is provided by the entertainment machine 100 of FIG. 1, which comprises a cabinet 102 which houses a Cathode Ray Tube (CRT) display 104. The cabinet 102 also houses, at a convenient user-operable height, a coin slot 108 arranged to accept coins as a payment for a game and four input buttons 110a, 110b, 110c, 110d. The machine 100 further comprises a coin payout tray 112 from which a prize won may be collected and, inside the cabinet 102, processing circuitry 114 arranged to provide a game on the display 104 and to accept inputs from the input buttons 110a, 110b, 110c, 110d to control a game provided by the machine. Also inside the cabinet 102 is a memory portion 118 arranged to maintain a local free prize fund reflecting the value of a local free prize which may be awarded from the machine. The coin payout tray 112 in conjunction with the processing circuitry 114 may be thought of as a free prize award mechanism. The machine further comprises an aerial 116 which provides a connection means arranged to allow a GSM connection to be made to a Network as shown in FIG. 4, in this example, the Internet 400. As will become apparent from the ensuing description, there are two levels of value of free prize available. The first level of prize and its availability is determined by the local free prize fund and the second level of prize and its availability is determined remotely from the prize machine 100 by a computer 402, providing a processing means, in communication with a number of prize machines 100 via a GSM connection to the Internet 400 as is shown in FIG. 4.

In the embodiment being described the display 104 comprises a touch sensitive display and is capable of displaying a virtual keyboard. Such a virtual keyboard provides an input means allowing a player to enter name, address, PIN number, etc. should he/she be required to do so. A real keyboard, other data entering means may be provided in other embodiments.

The machine 100 is arranged to provide a first service, which in this embodiment comprises a game and a second service, which in this embodiment also comprises a game, but specifically a game in which a free prize may be won. For the purposes of this example, the game of the first service is a video poker game, in which the player makes a payment to the machine 100 and gambles on winning a pay-to-play prize. The game of the second service comprises a simple ten-second countdown in which time the player must make a predetermined input using one or more of the input buttons 110a, 110b, 110c, 110d to win a free prize. The free prize may be of the first level or the second level in value.

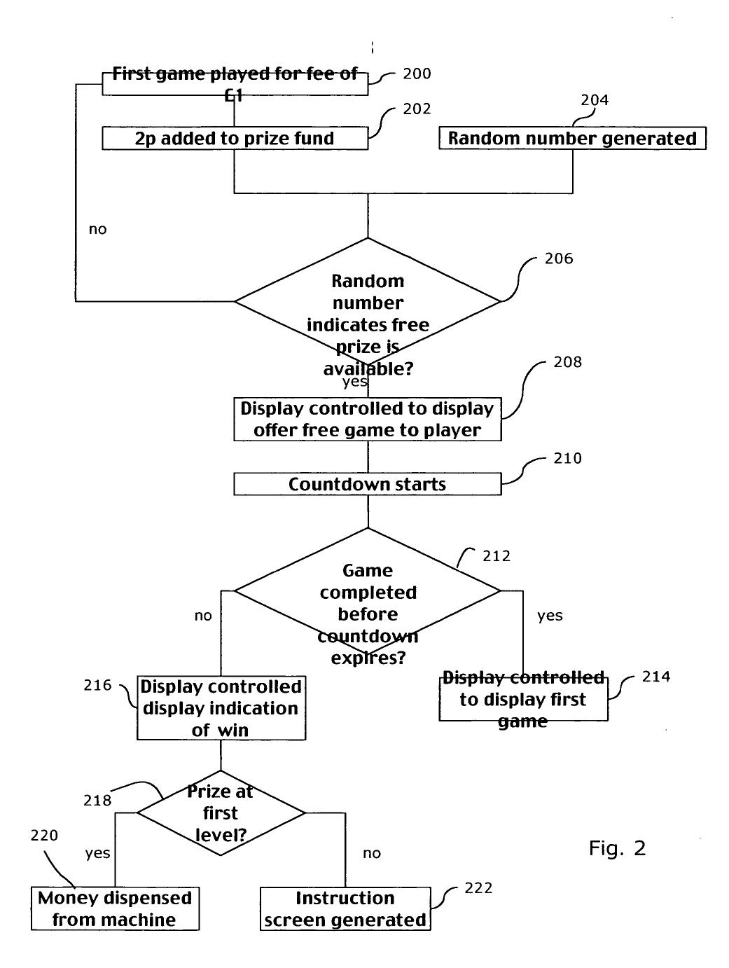

Generally, the machine 100 provides the first service. However, from time to time during the time at which the machine 100 is available for play, and whether or not the machine is being played at that time, the second service (i.e. the game) is offered as follows and as is shown in the flow chart of FIG. 2.

In step 200, the display 104 is controlled by the processing circuitry 114 to allow the game of the first service to be played for a charge of one pound. Two pence is added to the free prize fund and the new value is stored in the local free prize fund memory portion 118 (step 202).

A random number is generated every hour by the processing circuitry 114 in step 204. In step 206, this random number is used to determine whether the game of the second service should be made available to a player with the free prize being offered at the first prize level. The probability with which this occurs may be determined in the example that follows:

If the number of free prizes won within the year is set at 20 then a prize will be won on average every 18.25 days or every 438 hours. Therefore, the processing circuitry 114 generates a number between one and 438 and if the number is a one, the machine is controlled to make the game of the second service available to the player. Otherwise, the game of the first service remains available.

Assuming that the processing circuitry 114 has generated a one, the display 104 is controlled by the processing circuitry 114 to display an indication that the game of the second service is available free of charge as step 208. The ten-second countdown then commences and is displayed on the machine (step 210). Thus, a player should make an input to the machine 100 in this 10-second period in order to win the prize and this may be thought of a condition for winning the free-prize. The skilled person may appreciate that this game may instead be a game of skill, or indeed be set up such that in any particular game a player may not be able to win the prize, although no indication of this will be made to the user.

The game of the second service is also offered with a free prize at the second prize level, which it will be appreciated is generally of higher value than the first prize level. A free prize at the first prize level may for example be £1, £5 or £10; a free prize at the second prize level may for example be £10,000 to £50,000.

The frequency with which the second prize level is made available may be determined automatically, at random, by manual intervention or a combination of these. The computer 402 selects one machine 100 forming part of the network at random to make the free prize available and controls and/or communicates with to cause the machine 100 to proceed with the game as described in relation to steps 208 and 210.

If, according to step 212, a player fails to make the required input in within the time limit (perhaps because no player was playing the game of the first service or in the proximity of the machine when the game of the second service was offered), the display 104 is controlled to display an indication that the first game is again available (Step 214). As such, the display 104 is being used as a prize display means for the second service. If, in the alternative, the required input is made within the time limit, the display 104 is controlled to display an indication to that effect (step 216).

If the free prize is to be awarded at the first level (step 218), then and the processing circuitry 114 causes the value of the prize to be dispensed to the coin payout tray 112 in step 220.

If the free prize is to be awarded at the second prize level (step 218), the machine 100 suspends play and shows as step 222 a Free Prize claim screen instructing that, to claim the prize, the player should immediately enter and confirm a 4 digit PIN, which he/she should remember and keep secret, then further instructing that the player should seek assistance from a member of staff. The display 104 would display this screen until the acting manager resets the machine using a refill key. The acting manager gives the free prize winner a pre-printed “winner's ticket” which contains the following information: amount won (written in by manager), location (pre-printed), date and time (written in by manager), name of winner (written in by manager), signature of winner, contact number for winner (written by manager), name of acting manager (written in by manager), signature of acting manager and a contact telephone number for administrator (pre-printed). The machine 100 may of course be arranged to print any or all of the above information using a printing means.

The winner's ticket may be duplicated, allowing both the winner and acting manager to retain a copy. To claim the prize, the winner should contact the administrator using the contact telephone number for administrator on the winner's ticket. The administrator, after verifying the authenticity of the claim by requesting the PIN number input to the machine, can agree with the winner on how the prize should be paid, for example by cheque through the post or by electronic funds transfer to the winner's bank account. The identity of the location and the time and date the free prize was won can also be used to verify the claim. As an additional security check the administrator could obtain and match the copies of the winner's ticket from the winner and the manager.

Once the free prize at the second level has been won, the machine 100 confirms this event to the computer 402 together with details such as the winner's PIN, date, time, location and the value of free prize awarded. If the free prize is not won within a given period (for example 4 hours) on a particular machine, the opportunity to win the free prize at the second level is removed from that machine 100 and a further machine 100 selected and the free prize at the second level is made available on that machine 100. Once the free prize at the second level is confirmed as won (but at this point not paid), the computer 402 communicates with all machines 100 set their free prize totals to a starting level.

It will be appreciated from the above description that the game of the second service is available free of charge. This may exempt the game for legislation or other rules or conditions limiting the size of the prize. The value of the free prize may therefore be unlimited and could, for example to £10,000, £1 m, etc.

A second embodiment is now described with reference to FIG. 3 which shows a network comprising a plurality of machines 100 such as were described in relation to the first aspect of the invention placed in view of a free prize display 300. A free prize display 300 comprises a display portion 302 and processing circuitry 304. The machines 100 are each connected to the free prize display 300 by a bus cable 306. The bus cables 306 are arranged to carry signals from the processing circuitry 114 of each machine to the processing circuitry 304 of the free prize display 300.

In this second embodiment, the free prize is incremented over time according to the following example criteria:

If total free prize fund over 12 months is £50,000, a minimum free prize is £500 and the number of free prizes won within the year is 20 then—
Average free prize=£50,000/20=£2500
Average days between free prizes=365/20=18.25
Average free prize increment per day=(£2500−£500)/18.25=£110
Average free prize increment per opening hour=£109/12=£9
Average free prize increment per second=£9/3600=2.5 p

The time period between awards of the free prize is caused to vary so that they cannot be easily anticipated by a player. This period should be selected at random say between 1 day and 36 days (twice the average time span of 18.25 days between free prizes). This results in a variation of between £610 (£500+£110) and £4460 (£500+36*£110) in the free prize total.

If it is determined that the free prize should be made available then the second game is then played as outlined above in relation to FIG. 2.

It will be appreciated that there are many possible embodiments of the present invention. Such embodiments include providing the game of the second service as a game of skill, such as a general knowledge quiz or a shooting game, or as a game of chance, such as a hi/lo gamble. The game of the second service may alternatively simply be a free-of-charge version of the game of the first service.

Moreover, there are many possible variations on the methods of awarding a prize. These may include asking the winner of a free prize to input his/her name and address such that a cheque for the amount of their winnings could subsequently be mailed to them. They may also be required to enter a Personal Identification Number (PIN) which must be supplied to an administrator at a later time to collect the prize. The PIN may be thought of as a passcode. Alternatively, the player may, on winning the second game, be entered into a prize draw and a free prize at the second level may be awarded to the winner of that draw.

It will be appreciated that the connection to the Internet 400 need not be a GSM (Global System for Mobile communications) connection. In other embodiments the network may be provided by any other protocol including any of the following, non-exhaustive list: UMTS (Universal Mobile Telecommunications System); GPRS (General Packet Radio Service); WIFI (Wireless Fidelity—otherwise known as IEEE802.11); Ethernet; a telephone connection (including Broadband, etc.); an ADSL (Asymmetric Dynamic Subscriber Line) connection; or the like. Indeed a connection to the Internet may not be provided and the connection could be to a separate Wide Area Network (WAN).

Machines provided in a network; i.e. network machines need not all be in the same location as shown in the embodiment of FIG. 2. They could be spread between several geographical locations. The free prize total could be displayed at each of the locations or in various places to attract players to the machines from the vicinity. The machines could be linked via telecommunication links. There could be more than one free prize display means 300 and indeed the free prize display means 300 may be remote from the machines 100.

The skilled person will appreciate that it is common to provide a plurality of entertainment machines in a single location. A prize machine according to an aspect of the invention may be provided in such a location in order to encourage players to visit that location. Such a prize machine may be provided as part of the one of the entertainment machines or may be provided as a separate unit. Should the prize machine comprise a separate unit then a ‘first service’ may not be offered.

In some embodiments of the invention the prize machine 100 may be arranged such that a game provided by the first service is time-limited; i.e. there is a time limit in which the game should be played. Such a time limit is advantageous because it helps to prevent players loitering whilst the machine 100 is providing the first service in order to increase the chance of that player being able to play the game provided by the second service.

Reference is made herein to free prize which may be provided at a first level and a second level. Reference to free prize is some contexts is intended to cover free prizes offered at both the first and second level.

1. A prize machine comprising an input means capable of receiving inputs from a user, said inputs being arranged to control said machine, and a prize award mechanism capable of issuing prizes to a user, wherein said machine is arranged to periodically provide an opportunity, free of charge to a user and independently of any user input to said machine, of winning a prize issued by said prize award mechanism by making a predetermined input to said machine using said input means.

2. A prize machine according to claim 1 which comprises an entertainment machine which may be any of the following: an AWP machine (Amusement With Prizes); an SWP machine (Skill With Prizes); a gaming machine.

3. A prize machine according to claim 2 which is arranged to offer a pay-to-play prize, available following payment to said machine, in addition to said free prize.

4. A prize machine according to claim 1 in which said machine is arranged to award said free prize such that the value of said free prize is at substantially two different levels: a first level and a second level.

5. A prize machine according to claim 4 in which said prize award mechanism is arranged to pay out free prizes at said first level and said machine further comprises an alternative prize award mechanism capable of issuing prize information such that prizes at said second level can be collected by a user although said prize is not paid directly from said machine.

6. A prize machine according to claim 1 in which said machine is arranged such that periods between offers of free prizes is variable.

7. A prize machine according to claim 1 which is arranged to provide a first service and said opportunity to win said free prize is provided as a second service.

8. A prize machine according to claim 7 in which said machine is capable of varying a value of a free prize and is arranged such that said value of a free prize available from said machine at at least one of said first and second level is increased each time said first service is used.

9. A prize machine according to claim 7 which has a means capable of allowing at least one prize fund to be accessed and which is arranged such that said free prize is provided from at least one of said prize funds, said machine being further arranged such that said value of at least one of said prize funds increases each time said first service is used.

10. A prize machine according to claim 9 which is arranged such that a free prize is made available when at least one of said prize funds has reached a predetermined threshold value.

11. A prize machine according to claim 7 which is arranged such that a length of time for which a user is able to use said first service is time-limited.

12. A prize machine according to claim 1 in which said prize machine comprises a connection means capable of connecting said prize machine to at least one further device and arranged to allow said machine to be connected to at least one of the following: a further prize machine, a prize display means, a network of prize machines, a computer network, a telecommunication network.

13. A prize machine according to claim 1 which comprises an input means capable of allowing a user to input data and arranged such that a winner of a free prize can input details into said machine.

14. A prize machine according to claim 13 in which said input details comprise at least one of contact details for said winner and a passcode.

15. A network of prize machines according to claim 1.

16. A network according to claim 15 which is arranged such that at least one prize fund is accessible across said network and any machine on said network may offer a free prize from that prize fund.

17. A network according to claim 15 which network comprises a processing means capable of communicating with each said machines connected to said network and arranged to determine at least one of the following in relation to prizes made at said second level: value; frequency; timing of; a machine on which an offer of a free prize is made.

18. A method of increasing the appeal of a prize machine by providing an unlimited value prize, said method comprising providing a prize machine capable of offering a prize and of accepting payments, said machine comprising an input means capable of receiving inputs for a user and of controlling said machine and periodically causing said prize machine on input of a predetermined input machine to offer a prize without requiring either of a payment to be made and prior input to be made to said machine.

19. A method according to claim 18 which further comprises offering a first service from said prize machine and a provision of a game having a free prize constitutes a second service.

20. A method according to claim 18 which further comprises providing a condition for awarding said free prize wherein said condition must be satisfied before said free prize is awarded.

21. A method according to claim 20 in which said condition comprises at least one of winning a game and making an input.

22. A method according to claim 18 which comprises connecting said prize machine to a network.
